(19) United States
(12) Patent Application Publication
(10) Pub. No.: US 2021/0298972 A1
(43) Pub. Date: Sep. 30, 2021

(54) RETRACTABLE BED FOR SUBJECTS WITH LIMITED OR NO MOBILITY

(71) Applicants: Eduardo CERVERA AGUIRRE, Ciudad de México (MX); Ligia Beatriz RODRÍGUEZ AGUILAR, Ciudad de México (MX)

(72) Inventor: Ligia Beatriz Rodriguez Aguilar, Mexico City (MX)

(73) Assignees: Ligia Beatriz Rodriguez-Aguilar, Ciudad de México (MX); Eduardo Beatriz Cervera-Aguirre, Ciudad de México (MX)

(21) Appl. No.: 16/973,694

(22) PCT Filed: Dec. 18, 2018
(86) PCT No.: PCT/MX2018/000160

§ 371 Date: Dec. 9, 2020

(51) Int. Cl. A61G 7/02; A61G 7/015

(52) U.S. Cl. CPC A61G 7/02; A61G 7/015

(57) ABSTRACT

The present invention is a bed for in-patients or mobility-limited or non-mobility individuals, consisting of a retractable bed that allows the patient or individual to defecate and urinate without leaving the bed. The bed is divided into two structures and comprises a special mattress, also divided into two sections, two levers located on the side of the bed, a back rest, a soft toilet seat, a plate or support structure, a basin-shaped container, a light bell, two levers on the side of the bed that transmit force and displacement and, when pulled by the patient, cause the two bed structures to separate and they lift the seatback and initiate the entry of the soft, toilet-like seat into the plate or support structure, with the container or basin.

### FIELD OF INVENTION

The field of application of this invention relates to in-patients or individuals with reduced mobility, and even without mobility. The invention refers to a retractable bed that allows a non-mobile person to defecate and urinate without leaving the bed. The application of this invention is not limited to in-patients as it may be installed in the house of the patient or individual without mobility.

### BACKGROUND OF THE INVENTION

There are several patents relevant to the retractable bed in this invention. U.S. Pat. No. 7,523,515 B2 from Hill-Rom Services, Inc. Wilmington, with filing date on Apr. 28, 2009, discloses a patient support that has an adjustable length cover, and a mattress that can be placed on the cover. The mattress includes a foot portion that is adjustable in length.

Also, U.S. Pat. No. 3,237,212 from Hill-Rom Company, Inc. Batesville, Ind., a Corporation of Indiana, with filing date on Mar. 1, 1966, reports electrically operated hospital beds and is primarily intended to provide a new and improved bed of this type. It is a primary objective of the invention to provide a hospital bed in which the seat and leg sections of the bed automatically move toward the head while lifting the head section of the bed, in order to move the patient, who is in a reclined or seated position in the bed, toward the end of the head of the bed, resulting in a cabinet next to the adjacent bed being equally accessible to the patient in all patient positions in the bed.

On the other hand, U.S. Pat. No. 7,712,167 B2, released Jul. 2, 2008, with priority claim FR 07 56317, discloses a bed with a mobile side barrier comprising a main barrier element and a bottom extensor. The main barrier element is associated with a deformable parallelogram mechanism articulated to a bed frame; this mechanism includes a deployment bar articulated between two parallel arms, and the bottom extensor is attached to the unfolding bar by a horizontal slide connection and is collapsed to slide along vertical guiding media supported by the main barrier element.

U.S. Pat. No. 8,370,978 B2 by Hill-Rom S.A.S., Pluvigner (FR), with filing date on Jul. 13, 2010, and the priority claimed FR 10 50299, is also known. It discloses a hospital bed equipped with a patient mobility aid device that has at least an adjustable lateral grip that helps the patient in performing certain movements, such as entering or leaving the bed. Patient mobility aid device includes a support crossbar that has a length oriented along one time the width of the bed. The couplers at the ends of the cross member attach to the bed frame elements. The crossbar covers at least one arm to which the adjustable side grip is attached. At least one arm extends and retracts with respect to the crossbar.

Also the Mexican patent MX 151283 with filing date on Aug. 19, 1980, discloses an improved hospital bed of the type that comprises, in combination, several generally movable sections such as a header section that usually rises, a middle section that usually remains static, and a foot section that can usually collapse up or down. All the sections are supported or held by a structure that, as a whole, allows the mattress to be correctly placed. In this case, the bed includes a motor that, when activated, moves the head section to either lower or raise it; a spindle screw which, when connected to the motor, moves the pipe section down or up; support screws through which it is possible to produce a turning motion to the bed so that the foot section, when descending, is placed under the middle section, thus shortening the overall length of the bed.

Finally, U.S. Pat. No. 9,138 173 B2 from Hill-Rom Services, Inc., Batesville, Ind. (US), with a priority date on Sep. 23, 2011, discloses a system for interoperability between the patient support device and various patient mobility devices. The system allows communication between the person support device and various patient mobility devices.

However, none of the patents mentioned herein provides a retractable bed system that allows a non-mobility or mobility-limited individual to be able to defecate and urinate without leaving the bed, which prevents sores and other health problems.

### BRIEF DESCRIPTION OF THE INVENTION

The non-mobility individual bed refers to a retractable bed that allows a mobility-limited patient to defecate and urinate without leaving the bed. When in bed, the patient pulls two levers, which are two rigid bars, to transmit force and displacement, which are on the sides, and the upper half or base of the bed retracts onto two rails while a comfortable seating collector is pulled into a plate or sheet, with a container underneath, leaving the patient on top of the plate. At the same time, the lower section of the bed moves downwards to allow such an opening between both sections of the bed so that the seat can be placed in the middle and the patient can perform urine or defecation needs without exerting great effort. The lever actuator to move both sections of the bed over the rails can be a solely mechanical or electrical mechanism that would further reduce the effort to achieve proper container positioning. The retractable bed of this invention solves the problem of the patient performing his/her personal and intimate biological functions, all by him/herself and in the bed. One or two people, whether nurses, family members, etc., are not required to clean and tidy up the patient, several times during the day and night, after patient performs his/her personal biological functions. On the other hand, from an ecological point of view, the use of disposable diapers would be reduced and the level of hygiene in the patient area would be considerably increased.

### BRIEF DESCRIPTION OF THE DRAWINGS

The attached drawings, which are incorporated in and constitute a part of the description, illustrate one or more modalities and, together with the description, explain these modalities. In drawings:

FIG. 1 shows a perspective view of the retractable bed of the invention.

FIG. 2 shows a perspective view of the retractable bed of the invention.

FIG. 3 shows a perspective view of the head section of the retractable bed of the invention.

FIG. 4 shows a perspective view of the retractable bed of the invention.

FIG. 5 shows a perspective view of the seat/container section of the retractable bed of the invention.

FIG. 6 shows a perspective view of the lower section of the retractable bed of the invention.

FIG. 7 shows a perspective view of the footboard of the retractable bed of the invention.

### DETAILED DESCRIPTION OF THE INVENTION

The following description of the manufacturing examples refers to the attached drawings. The same reference numbers in different drawings identify the same or similar elements. The following detailed description does not limit the invention. Rather, the scope of the invention is defined by the attached claims.

The present invention is a bed system for individuals with limited mobility or without mobility consisting of a retractable bed that allows a patient without mobility to go to the bathroom alone, without leaving his/her bed. It is a bed divided into two bases or structures, with special mattresses, also divided into two, that avoid sores and other health problems. The upper section (where the head and trunk rest) has three positions. On the sides it has two levers (bar type) to transmit force and displacement which, when pulled, the patient him/herself, separates the two structures, lifts the backrest and initiates the entry of the soft seat (like a toilet seat) into a plate- or support-type structure, with the collection vessel or basin. At the same time, the lower section of the bed moves downwards to allow such an opening between both sections of the bed so that the seat can be placed in the middle and the patient can perform urine or defecation needs without exerting great effort. The lever actuator to move both sections of the bed over the rails can be a solely mechanical or electrical mechanism that would further reduce the effort to achieve proper container positioning. Then, when the patient is finished using it, the same levers remove the container and the two platform boards or supports are reattached. Then, with a bell or light button, the patient calls his/her caregiver to come to look for the used container and leave in place a clean one, which bears the number of the same bed, so that they do not exchange containers during the same patient's cycle, for hygiene and health reasons. The other part of the structure has two positions for comfort on the legs.

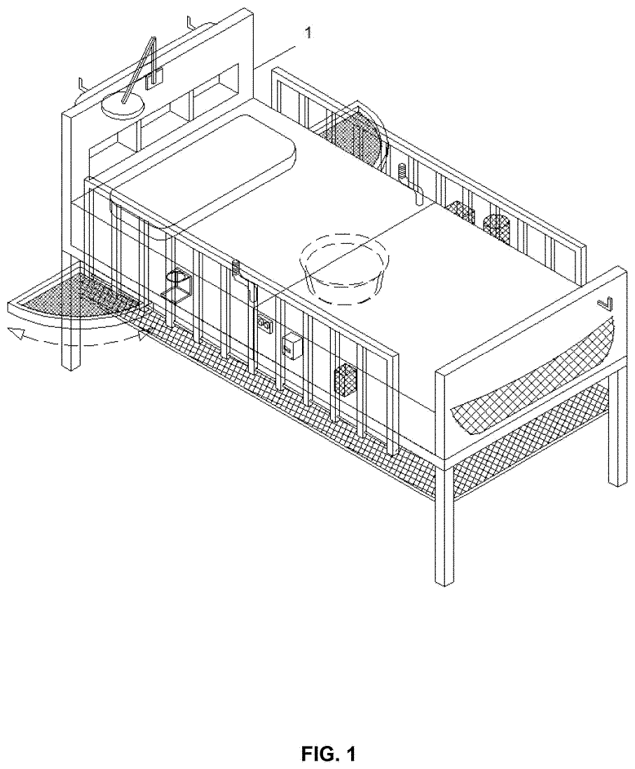

FIG. 1 shows a perspective view of the retractable bed of the invention.

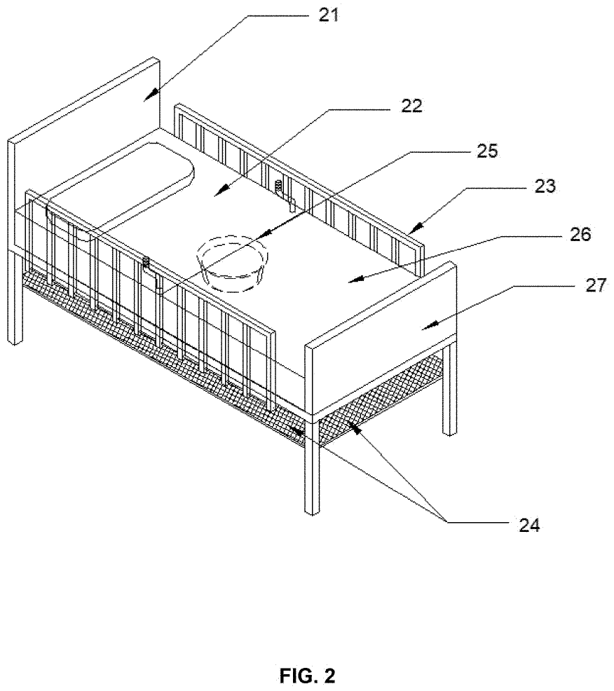

FIG. 2 shows a perspective view of the retractable bed of the invention comprising the parts that integrate it as a head 21, a reclining upper section 22, folding railing 23 on both sides, an auxiliary grill 24 to seat blankets, briefcases, etc., a seat/physiological waste container section 25, a lower section 26 that slides outward, including the footboard, in order to leave visible and available the physiologic waste receptor 25 and a footboard 27.

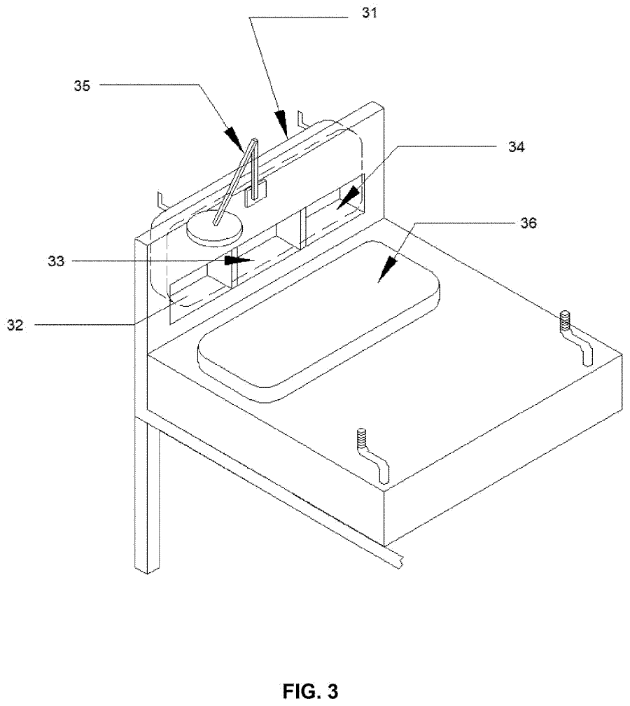

FIG. 3 shows a perspective view of the head of the retractable bed of the invention comprising an extra pillow 31 available on the back of the head of the bed fixed with special hooks, a niche 32 for placing books or magazines, a niche 33 for placing a hand mirror, facial tissues, etc.; a niche 34 for placing body creams, ointments, etc.; a yellow light multi-position lamp 35 and a pillow 36.

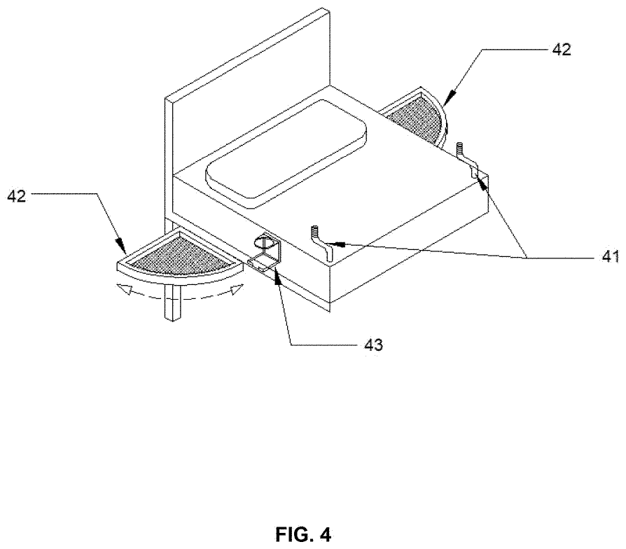

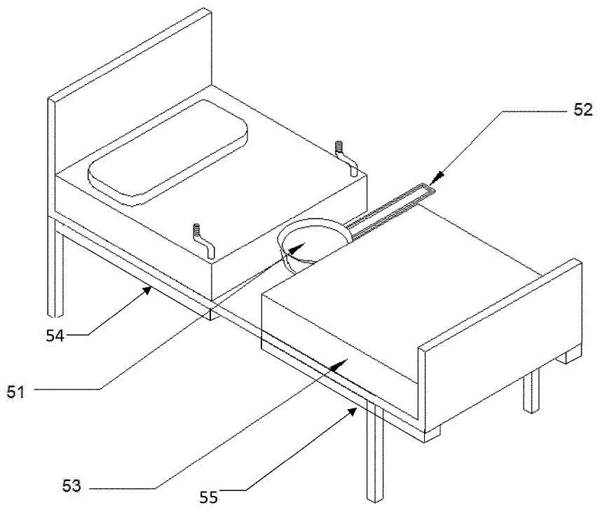

FIG. 4 shows a perspective view of the upper reclining section of the retractable bed of the invention comprising 43 handlebars to control the position and movements of the upper (reclining) and lower mattresses, which can be operated manually or electrically; they allow the mattresses to be separated in order to leave exposed and in suitable position the physiological waste container for use by the patient, auxiliary tables 42 that can be stored on the sides of the bed, with raised edges and a folding cup or bottle holder 43. Handlebars 41 control the position of the mattresses (top and bottom) of the bed, they can be of two types; Electronic and mechanical. The reclining upper section lifts mechanically and in coordination with the mattress separation (reclining upper part and lower part) so that the patient comfortably takes on the convenient position for use of the physiological waste container.

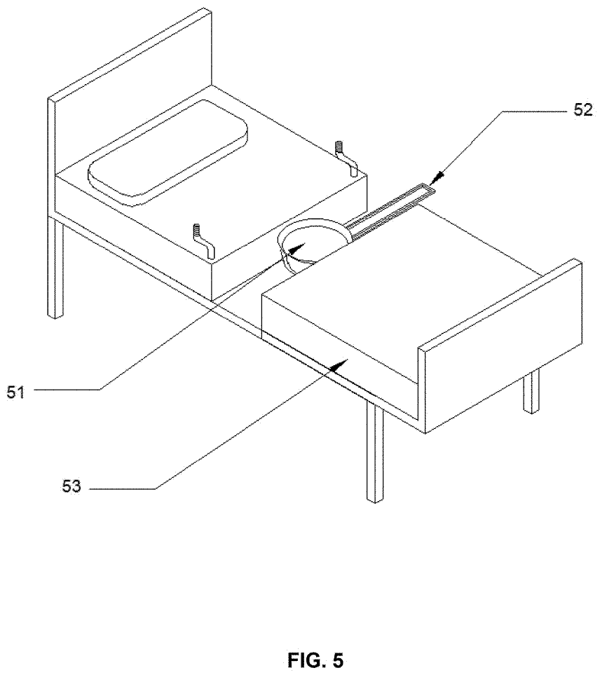

FIG. 5 shows a perspective view of the seat/container section of the retractable bed of the invention comprising a physiological waste container 51, which is visible and available for use by the patient when the mattresses are separated (reclining upper part and lower part) in response to the manipulation of the control handles, an easy-to-use handle 52 which allows for the removal of the physiological waste container in a drawer-like way; the physiological waste container must be replaced with another previously disinfected and clean container; a lower section 53 that slides out including the footboard of the retractable bed of the invention, in order to leave exposed and make available the waste container, achieving displacement by means of the upper rails 54 and lower rails 55, over which the position levers slide.

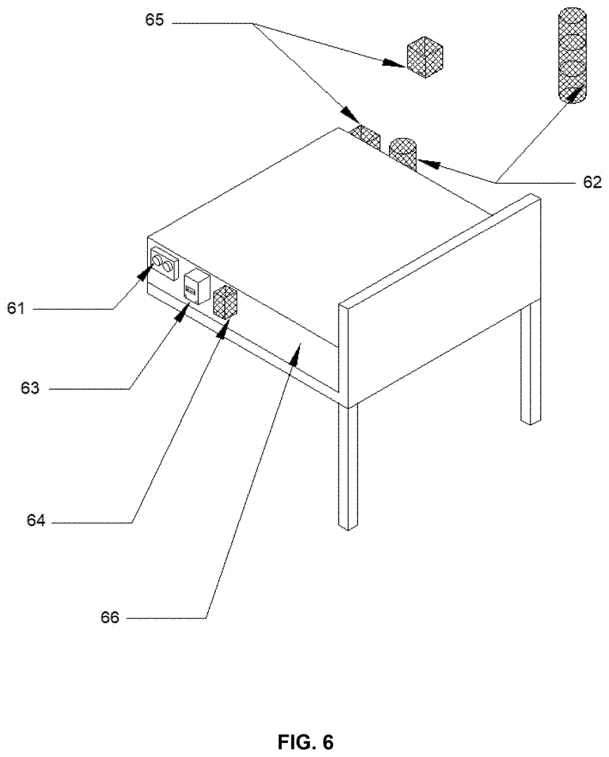

FIG. 6 shows a perspective view of the bottom section of the retractable bed of the invention comprising a light and sound switch 61 to request that the replacement of the physiological waste container. The light notice is located outside the patient's room and at the nursing station, and the audible warning is located only at the nursing station; a folding tubular tray 62 for sanitary paper rolls with a capacity of 3 rolls; a folding basket 63 for placing packages of wet and sanitizing towels, a folding basket 64, for environmental deodorant, a folding basket 65 for bags for placing used wet papers and towels, and trash in general, and a lower section 66 that slides out including the footboard of the retractable bed of the invention, in order to leave visible and available the physiological waste container.

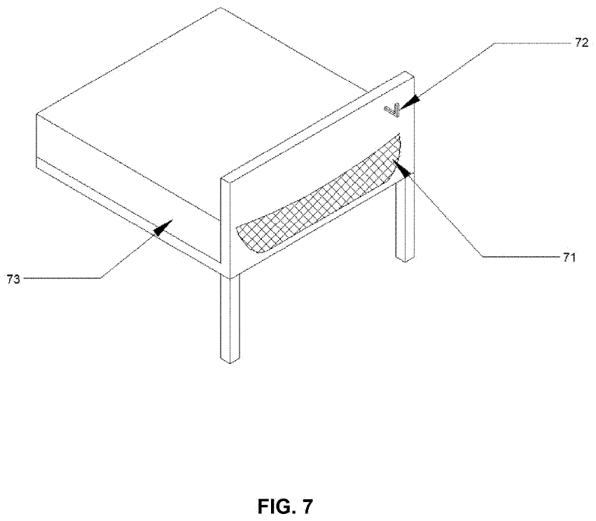

FIG. 7 shows a perspective view of the footboard of the retractable bed of the invention comprising a flexible compartment 71 made of textile or metallic material for placing dirty clothing or similar stuff, a hook 72 for placing clipboard and a bottom section 73 of the retractable bed of the invention that slides outward, including the footboard, in order to leave exposed and available the physiological waste container.

1. A retractable bed system for mobility-limited or non-mobility individuals, comprising:
a bed divided into an upper structure and a lower structure
a special mattress, also divided into two sections
two levers located on the side of the bed
two travel rails for the upper structure of the bed
two travel rails for the bottom structure of the bed
one backrest
one soft, toilet-type seat
one plate or support type structure
one collection container
one light button
Where the levers on the side of the bed transmit force and displacement, when pulled by the patient, cause the two bed structures to separate. They also raise the seatback and initiate the soft toilet seat entry into the plate or support structure, with the collecting container.

2. The retractable bed system according to claim 1, in which, when the patient finishes using the soft seat as toilet, the same levers operate the removal of that container and the two platform structures are reattached.

3. The retractable bed system according to claim 1, wherein the displacement drive can be carried out by mechanical or electrical means.

4. The retractable bed system according to claim 1, wherein, by means of the light bell, the patient calls his/her caregivers to come to look for the used container and leave in place a clean container, which carries the number of the bed.
